(19) United States
(12) Patent Application Publication
(10) Pub. No.: US 2004/0183627 A1
(43) Pub. Date: Sep. 23, 2004

(54) Compact waveguide filter

(76) Inventors: Dominique Lo Hine Tong, Rennes (FR); Charline Guguen, Rennes (FR); Francois Baron, Cesson Sevigne (FR)

Correspondence Address: THOMSON MULTIMEDIA LICENSING INC, JOSEPH S TRIPOLI, PO BOX 5312, 2 INDEPENDENCE WAY, PRINCETON, NJ, 08543-5312, US

(21) Appl. No.: 10/767,295

(22) Filed: Jan. 29, 2004

(30) Foreign Application Priority Data
Feb. 3, 2003 (FR) 0301504

(51) Int. Cl. H01P 1/208

(52) U.S. Cl. 333/212; 333/26

(57) ABSTRACT

The invention provides a particularly compact waveguide-type filter that can be easily adapted to a microstrip circuit. The waveguide filter comprises at least three mutually coupled resonant cavities 14 to 19. The filter is coupled to a microstrip circuit placed on a substrate 10. At least one cavity 14, 15, 18 and 19 lies on one side of the substrate 10 and at least one other cavity 16, 17 lies on the other side of the substrate 10. The cavities distributed on either side of the substrate have the effect of greatly reducing the size of the filter. The invention also relates to an outdoor transmission unit that includes the said filter.

### BACKGROUND OF THE INVENTION

1. Field of the Invention

The invention relates to a compact waveguide filter.

More particularly, this type of filter is intended for microwave transmission systems.

2. Prior Art

Within the context of satellite broadcasting in the Ka band, a transmission system must comply with the ETSI EN301459 recommendations. An example of an outdoor transmission unit is shown in FIG. 1.

The outdoor transmission unit receives a signal in the intermediate band, which comes from a distant indoor unit. A first amplifier 1 amplifies the signal and delivers it to a mixer 2. An oscillator 3 cooperates with the mixer 2 to transpose the amplified signal into a transmission frequency band. A second amplifier 4 amplifies the signal coming from a mixer 2 and delivers an amplified signal to a band-pass filter 5. The band-pass filter 5 selects the transmission frequency band and rejects the other frequencies with a high attenuation. A third amplifier 6 amplifies the filtered signal and delivers it to an antenna. The antenna (not shown) is, for example, a horn-type waveguide antenna, this being placed facing a parabolic reflector.

The outdoor unit is produced in a technology which makes it possible to work with very high frequencies, for example around 30 GHz. In particular, it is known to use a microstrip-type technology. However, producing the band-pass filter 5 in microstrip technology poses a few problems since the Q-factor of the filters in this technology is not very high. A waveguide filter of much higher Q-factor may be used, but this is generally very bulky in terms of circuit size.

### SUMMARY OF THE INVENTION

The invention provides a particularly compact waveguide-type filter and can be easily adapted to a microstrip circuit. According to the invention, the cavities are distributed on either side of the substrate, this having the effect of greatly reducing their size.

The invention is a waveguide filter comprising at least three mutually coupled resonant cavities, the filter being coupled to a microstrip circuit placed on a substrate. At least one cavity lies on one side of the substrate and at least one other cavity lies on the other side of the substrate.

Preferably, the side of the cavity lying against the substrate is electrically closed by an earth plane supported by the substrate. The coupling between at least two cavities, lying on either side of the substrate takes place via a slot in the earth plane or planes separating the said cavities. The substrate is cut at the slot and the edges of the slot are metallized. The coupling between the microstrip circuit and one of the access cavities of the filter takes place via a slot in the earth plane of the said cavity, the said slot being placed beneath an open-circuit microstrip line.

According to one particular embodiment, the filter comprises: a first cavity placed on a first side of the substrate, the substrate being covered by an earth plane pierced by a first coupling slot, a first microstrip line being placed on a second side of the substrate above the coupling slot so as to couple the said filter to the microstrip circuit; a second cavity placed on the first side of the substrate and coupled to the first cavity via a first lateral slot; a third cavity placed on the second side of the substrate and coupled to the second cavity via a second coupling slot passing through the substrate; a fourth cavity placed on the second side of the substrate and coupled to the third cavity via a second lateral slot; a fifth cavity placed on the first side of the substrate and coupled to the fourth cavity via a third coupling slot passing through the substrate; and a sixth cavity placed on the first side and coupled to the fifth cavity via a third lateral slot, the substrate being covered with an earth plane pierced by a fourth coupling slot, a second microstrip line being placed on the second side of the substrate above the fourth coupling slot so as to couple the said filter to the microstrip circuit.

The invention is also an outdoor transmission unit which transposes a signal from an intermediate band into a transmission frequency band, the said unit comprising a substrate on which a circuit is produced in microstrip technology, the said circuit comprising amplification means, transposition means and filtering means as defined above.

### BRIEF DESCRIPTION OF THE DRAWINGS

The invention will be more clearly understood and other features and advantages will become apparent on reading the description that follows, the description being given with reference to the appended drawings in which:

FIG. 1 shows an outdoor transmission unit according to a known technique;

FIG. 2 shows an exploded perspective view of a filter according to the invention;

FIG. 3 shows a top view of the filter of FIG. 2; and

FIG. 4 shows a sectional side view of this same filter, the line of section being indicated in FIG. 3.

### DETAILED DESCRIPTION OF THE PREFERRED EMBODIMENT

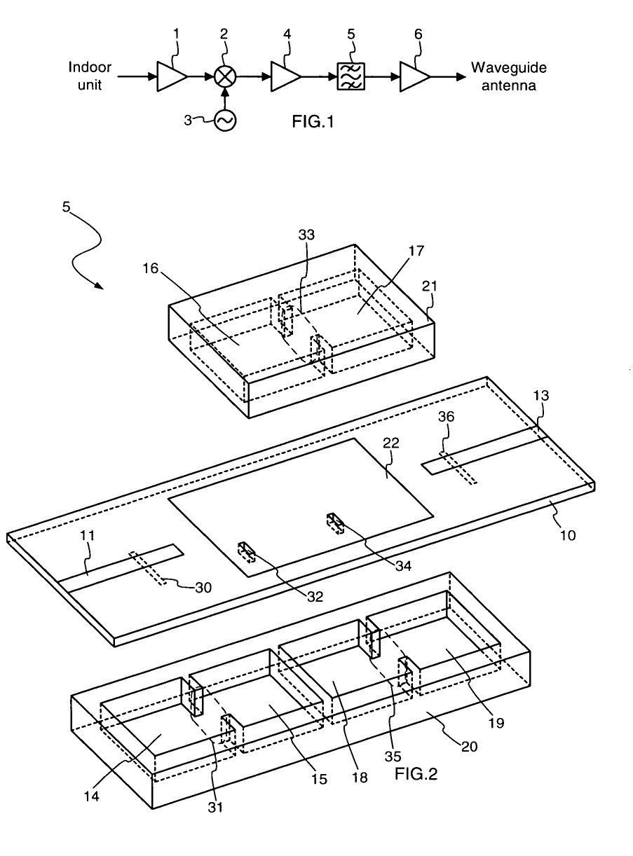

Having been described already, FIG. 1 will not be described in more detail. However, the components of this figure will be referred to in the rest of the description, the invention replacing the band-pass filter 5.

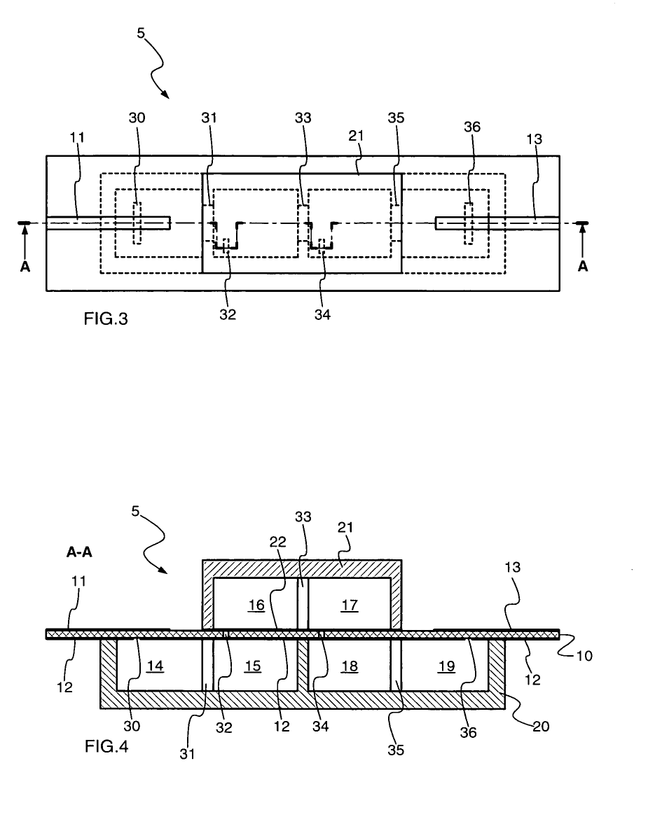

FIGS. 2 to 4 show a band-pass filter 5 produced according to the invention in waveguide technology. FIGS. 2 to 4 correspond to an exploded perspective view, a top view and a view on the line of section A-A shown in FIG. 3, respectively. In these three figures, the same reference number corresponds to the same component. The following description will refer jointly to these FIGS. 2 to 4, which show, at different angles, the constituent components of the filter.

A substrate 10 supports a microstrip circuit (not shown) which corresponds to the rest of the circuit of the outdoor unit shown in FIG. 1. The substrate 10 is provided on its upper face with a first microstrip line 11, which is for example electrically connected to the output of the amplifier 4. The lower face of the substrate is covered almost completely with an earth plane 12. A second microstrip line 13 is placed on the upper face of the substrate, this second microstrip line being for example electrically connected to the input of the amplifier 6. The first and second microstrip lines 11 and 13 constitute the input and the output, respectively, of the filter of the invention.

The filter 5 is a waveguide formed, in the example described, from first to sixth resonant cavities 14 to 19. The first, second, fifth and sixth cavities 14, 15, 18 and 19 are machined in a metal base 20. The base 20 is in electrical contact with the earth plane 12. The earth plane 12 furthermore serves to electrically close the cavities 14, 15, 18 and 19 of the base 20. The metal base 20 may extend over the entire surface of the substrate 10 so as to stiffen the said substrate 10 and ensure better conductivity of the earth plane 12. The third and fourth cavities are machined in a metal cap 21. The metal cap 21 is positioned on the substrate 10 above an earth plane 22 that extends over the entire surface of the cap 21. The earth plane 22 furthermore serves to electrically close the cavities 16 and 17 of the cap 21. The cap 21 is, for example, fixed to the base 20 by screws (not shown), thereby furthermore providing good electrical contact between the cap 21, the base 20 and the earth planes 12 and 22.

The first microstrip line 11 is coupled to the first cavity 14 via a first printed slot 30 which is produced on the earth plane 12. The second cavity 15 is coupled to the first cavity 14 via a first lateral slot 31 machined in the base 20. The third cavity 16 is coupled to the second cavity 15 via a first metallized slot 32. The fourth cavity 17 is coupled to the third cavity 16 via a second lateral slot 33 machined in the cap 21. The fifth cavity 18 is coupled to the fourth cavity 17 via a second metallized slot 34. The sixth cavity 19 is coupled to the fifth cavity 18 via a third lateral slot 35 machined in the base 20. The second microstrip line 13 is coupled to the sixth cavity 19 via a second printed slot 36, which is produced on the earth plane 12.

The first and second printed slots 30 and 36 are produced on the metal layer that constitutes the earth plane 12. The first and second metallized slots 32 and 34 are slots produced in the substrate 10 by punching, the edges of the slots being metallized so as to ensure good electrical continuity between the earth planes 12 and 22 and to prevent spurious propagation of the signal into the substrate 10 between the said earth planes 12 and 22.

The dimensions of the resonant cavities 14 to 19 and of the slots 30 to 36 are in accordance with the band-pass filter that it is desired to obtain. The response of the filter according to the invention is almost identical to the response of a conventional waveguide filter. However, the size of the filter is reduced lengthwise owing to the fact that the cavities are distributed above and below the substrate 10.

Many alternative versions of the invention are possible. The example described is a six-cavity filter. It would be possible to have a three-filter cavity, for example by eliminating the lateral slots 31, 33 and 35. However, the benefit of distributing the cavities on either side of the substrate 10 is less when the number of cavities is smaller, as the size of the filter is much smaller and poses fewer integration problems.

Likewise, it would be possible to have a filter with a much larger number of cavities, for which, in addition to the use of two faces of the substrate, it would be possible to use lateral slots placed on mutually perpendicular sides. The waveguide filter would then be folded on itself along two different directions.

The cavities shown are rectangular cavities but it would be quite possible to envisage a filter whose cavities are of different shape, for example cylindrical or hemispherical. Only that side of the cavity corresponding to the earth plane needs to be plane.

The cap 22 and the base 21 are indicated as being made of metal. Any material may be used for these components provided that it is conducting or covered with a conducting layer ensuring electrical continuity of the cavities.

In the above description, the filter is shown as being part of an outdoor transmission unit. The filter is particularly suitable for this type of device. However, this type of filter may be applicable to other microwave circuits.

1. Waveguide filter comprising at least three mutually coupled resonant cavities, the filter being coupled to a microstrip circuit placed on a substrate, wherein at least one cavity lies on one side of the substrate and at least one other cavity lies on the other side of the substrate.

2. Filter according to claim 1, wherein the side of the cavity lying against the substrate is electrically closed by an earth plane supported by the substrate.

3. Filter according to claim 2, wherein the coupling between at least two cavities lying on either side of the substrate takes place via a slot in the earth plane or planes separating the said cavities.

4. Filter according to claim 3, wherein the substrate is cut at the slot and the edges of the slot are metallized.

5. Filter according to claim 2, wherein the coupling between the microstrip circuit and one of the access cavities of the filter takes place via a slot in the earth plane of the said cavity, the said slot being placed beneath an open-circuit microstrip line.

6. Filter according to claim 1, wherein said filter comprises:
a first cavity placed on a first side of the substrate, the substrate being covered by an earth plane pierced by a first coupling slot, a first microstrip line being placed on a second side of the substrate above the coupling slot so as to couple the said filter to the microstrip circuit;
a second cavity placed on the first side of the substrate and coupled to the first cavity via a first lateral slot;
a third cavity placed on the second side of the substrate and coupled to the second cavity via a second coupling slot passing through the substrate;
a fourth cavity placed on the second side of the substrate and coupled to the third cavity via a second lateral slot;
a fifth cavity placed on the first side of the substrate and coupled to the fourth cavity via a third coupling slot passing through the substrate; and
a sixth cavity placed on the first side and coupled to the fifth cavity via a third lateral slot, the substrate being covered with an earth plane pierced by a fourth coupling slot, a second microstrip line being placed on the second side of the substrate above the fourth coupling slot so as to couple the said filter to the microstrip circuit.

7. Filter according to claim 6, wherein the substrate is covered with an earth plane over the entire surface of the substrate in contact with the cavity, with the exception of the coupling slots.

8. Outdoor transmission unit which transposes a signal from an intermediate band into a transmission frequency band, the said unit comprising a substrate on which a circuit in microstrip technology is produced, the said circuit comprising amplification means, transposition means and filtering means, wherein at least three mutually coupled resonant cavities, the filter being coupled to the circuit, and wherein at least one cavity lies on one side of the substrate and at least one other cavity lies on the other side of the substrate.

9. Unit according to claim 8, wherein the side of the cavity lying against the substrate is electrically closed by an earth plane supported by the substrate.

10. Unit according to claim 9, wherein the coupling between at least two cavities lying on either side of the substrate takes place via a slot in the earth plane or planes separating the said cavities.

11. Unit according to claim 10, wherein the substrate is cut at the slot and the edges of the slot are metallized.

12. Unit according to claim 9, wherein the coupling between the microstrip circuit and one of the access cavities of the filter takes place via a slot in the earth plane of the said cavity, the said slot being placed beneath an open-circuit microstrip line.

13. Unit according to claim 8 wherein the filter comprises:
a first cavity placed on a first side of the substrate, the substrate being covered by an earth plane pierced by a first coupling slot, a first microstrip line being placed on a second side of the substrate above the coupling slot so as to couple the said filter to the microstrip circuit;
a second cavity placed on the first side of the substrate and coupled to the first cavity via a first lateral slot;
a third cavity placed on the second side of the substrate and coupled to the second cavity via a second coupling slot passing through the substrate;
a fourth cavity placed on the second side of the substrate and coupled to the third cavity via a second lateral slot;
a fifth cavity placed on the first side of the substrate and coupled to the fourth cavity via a third coupling slot passing through the substrate; and
a sixth cavity placed on the first side and coupled to the fifth cavity via a third lateral slot, the substrate being covered with an earth plane pierced by a fourth coupling slot, a second microstrip line being placed on the second side of the substrate above the fourth coupling slot so as to couple the said filter to the microstrip circuit.
